(19) United States
(12) Patent Application Publication
(10) Pub. No.: US 2010/0088141 A1
(43) Pub. Date: Apr. 8, 2010

(54) PROCESS FOR COLLECTING OPERATIONAL AND CONDITIONAL INFORMATION ON INFRASTRUCTURES AND FOR RELATED PRIORITY SETTING

(76) Inventor: Michael Hill, Jacksonville, FL (US)

Correspondence Address: MCGUIREWOODS, LLP, 1750 TYSONS BLVD, SUITE 1800, MCLEAN, VA, 22102, US

(21) Appl. No.: 12/574,956

(22) Filed: Oct. 7, 2009

Related U.S. Application Data
(60) Provisional application No. 61/103,330, filed on Oct. 7, 2008.

(51) Int. Cl. G06Q 10/00; G06Q 50/00; G06F 17/30

(52) U.S. Cl. 705/8; 705/7; 705/10; 705/28; 707/E17.044

(57) ABSTRACT

A process and system to collect operational and conditional information on infrastructure such as railroads or pipelines, for example, is disclosed. The process includes techniques for organizing, sorting, evaluating and selecting capital investments in the infrastructure, including identification of higher risk for maintenance, and in the case of railroads for derailments, even though a specific location or portion of infrastructure may not have been identified for evaluation.

### CROSS REFERENCE TO RELATED APPLICATIONS

This application claims benefit and priority under 35 U.S.C. §119(e) from U.S. Provisional Application No. 61/103,330 filed Oct. 7, 2008, entitled A PROCESS FOR COLLECTING OPERATIONAL AND CONDITIONAL INFORMATION ON INFRASTRUCTURES AND FOR RELATED PRIORITY SETTING, the disclosure of which is incorporated by reference herein in its entirety.

### BACKGROUND OF THE INVENTION

1. Field of the Invention

The invention is related to a process for collecting and evaluating information related to capital projects and, more particularly, a process for collecting and evaluating information for decision making and capital outlay planning for infrastructure such as railroads or pipelines, for example, including basing prioritization on an evaluation of maintenance and/or operational risks for current portions of the infrastructure.

2. Related Art

Currently, business practices for identifying and prioritizing capital outlay and scheduling for ongoing maintenance projects involving infrastructure such as railroad lines and gas/oil pipelines, for example, lack front-end checks when specifics of maintenance project requests are initially identified and entered for consideration, such as when entered via a spreadsheet. For example, in a rail operation, inaccuracies may be introduced by the sequence of linking and sorting that may be required to match many, perhaps thousands, of track requests with track quality/usage data within a database or spreadsheet.

Engineer(s) typically require timely track (or other infrastructure) inspection information on which to base submissions. Capital planning may require that engineer(s), such as maintenance of way engineer(s), develop multiple alternative priority lists to analyze the best use of resources corporate-wide. Current manual processes typically require budget submission windows to be closed early in a fiscal year, further removing the planning information from the current needs of a track or infrastructure system.

Current planning and decision processes may lead to less than opportune decision making for repair, maintenance or new capital projects when current operational and infrastructure conditional risk factors are minimized in the decision process. Moreover, decisions may be based on aged information, or at least without consideration of very current information on infrastructure needs and conditions.

Accordingly, alternative techniques for timely prioritizing and identification of such risk factors for decision making and capital outlay may lead to better safety and timely maintenance.

### SUMMARY OF THE INVENTION

The invention meets the foregoing need and includes a method and apparatus to cost effectively and reliably identify risk factors for decision making and capital outlay which may lead to better safety and/or timely maintenance, among other improvements. The various aspects of the invention include acquiring, identifying risks and/or assigning risk levels, associated with portions of the infrastructure that may include at least any one of an environmental risk factor, an operational risk factor, an age risk factor, or a design risk factor. Examples of these may include, but not limited to, portions of infrastructure that have higher traffic demands (usage risk), portions of infrastructure that have more susceptible characteristics requiring higher maintenance cost outlay or frequency of repair (for example, portions of track with more curves (design risk), sharper curves (design and/or operational risk), higher average weight of traffic (operational risk), more traffic (operational risk), more adverse weather such as flooding, snow, earthquake areas (environmental and/or operational risk), bridges having higher age (design risk and/or operational risk), bridges of greater span (design risk and/or operational risk), and the like, or combinations of such characteristics).

Accordingly, in one aspect of the invention, a computerized process for determining capital outlay is provided that includes setting a priority and cost factor for a plurality of capital projects related to a railway system in an electronic database, applying a risk factor to each of the plurality of capital projects maintained by the electronic database and determining a capital budget for the plurality of capital projects based on the priority, cost, and applied risk and performing at least one capital project based on the determined budget, wherein the setting, applying, determining steps are executed on a computer processing platform.

In another aspect, a computer program product embodied in a computer readable medium that is accessible for execution, the computer program product includes machine executable instructions that when executed causes the execution of steps for determining capital outlay for a infrastructure system, the computer program product includes a first component to set a priority and cost factor for a plurality of capital projects related to a railway system in an electronic database, a second component to apply a risk factor to each of the plurality of capital projects maintained by the electronic database and a third component to determine a capital budget for the plurality of capital projects based on the priority, cost, and applied risk and performing at least one capital project based on the determined budget.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention, and together with the detailed description, serve to explain the principles of the invention. No attempt is made to show structural details of the invention in more detail than may be necessary for a fundamental understanding of the invention and the various ways in which it may be practiced. In the drawings:

FIG. 1A is a flow diagram showing steps of an embodiment for requesting capital, performed according to principles of the invention.

FIG. 1B is a flow diagram showing steps of an embodiment for a deferral decision process, performed according to principles of the invention.

FIG. 1C is a flow diagram showing steps of an embodiment for a capital life cycle plan, performed according to principles of the invention.

FIG. 1D is a flow diagram showing steps of an embodiment for a MoW plan analysis, performed according to principles of the invention.

FIG. 1E is a flow diagram showing steps of an embodiment for a MoW plan analysis, performed according to principles of the invention.

FIG. 2 is an illustration of an exemplary user interface for gaining access to portions of the TSCRMS, configured according to principles of the invention.

FIGS. 3A-3F are exemplary illustrations of graphs showing various exemplary types of data considered for use in priority setting, according to principles of the invention.

FIGS. 4A-4F are exemplary illustrations representing user interfaces of various functions provided by TSCRMS, and the corresponding software for performing the respective functions, configured according to principles of the invention.

FIG. 5 is an exemplary spreadsheet showing exemplary rating factors maintained by TSCRMS, which may be used to base capital decision making.

FIG. 6 is an exemplary user interface of TSCRMS for displaying various rating factors with low and high measures.

### DETAILED DESCRIPTION OF THE INVENTION

It is understood that the invention is not limited to the particular methodology, protocols, etc., described herein, as these may vary as the skilled artisan may recognize. It is also to be understood that the terminology used herein is used for the purpose of describing particular embodiments only, and is not intended to limit the scope of the invention. It is also to be noted that as used herein and in the appended claims, the singular forms “a,” “an,” and “the” include the plural reference unless the context clearly dictates otherwise. Thus, for example, a reference to “an address” is a reference to one or more addresses and equivalents thereof known to those skilled in the art.

Unless defined otherwise, all technical and scientific terms used herein have the same meanings as commonly understood by one of ordinary skill in the art to which the invention pertains. The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals reference similar parts throughout the several views of the drawings. References to people by a title such as “Engineer” and “MoW Staff” are exemplary, and may be a person of another title or functional responsibility.

In certain aspects, described more fully below, the Track Structure Capital Request Management System (TSCRMS) and associated method of the invention may leverage improvements in applications and communications infrastructure to improve request accuracy and timeliness. Moreover, the system and method of the invention may include improved accuracy, uniformity and timeliness of capital allocation and infrastructure projects based on actual data including wear on infrastructure such as track wear, defect rates, geometry, tonnage, and slow orders factors, among others. The TSCRMS may provide division engineer(s) staff with both timely inspection information to base their submissions and with automated validation of data entered.

The TSCRMS may provide maintenance of way (MoW) engineering staff with real time inventory of division requests along with track wear, defect, geometry and other information. The system may provide MoW engineer(s) a capability to dynamically set the weights for key decision factors in calculating MoW priority for requests across a corporation. The TSCRMS system may also alert division staff when production work may reduce the need for a track (or pipeline) structure job.

The TSCRMS, may improve the accuracy of the capital plan while reducing the delay between request submission and capital plan approval. Providing division engineer(s) staff with improved visibility of track quality information and the status of their capital requests may increase their ability to maintain the safety and operational readiness of rail track (or pipelines, if applied to such an infrastructure).

The TSCRMS may provide, among other benefits:
Reduced errors in the Track Structure Capital Plan due to improved data quality and request coordination.
Enabling division engineer(s) with track (or pipeline) quality information and Production Report data so that requests may accurately reflect current status.
Reduced time lag between closing of request budget window and finalization of capital plan.

The TSCRMS may improve the responsiveness, accuracy and visibility of the capital planning process. Creating an accurate capital request may require less time with the on-line validation of track information. Automation of project costing process may increase standardization of pricing among like projects. Customer service to corporate internal customers may be improved by providing the current status of requests.

The TSCRMS enables engineer(s) to take more proactive ownership of track work in their areas of responsibility by alerting them to changes in the quality of their track. The system may also alert company engineer(s) to production reports that may reduce the need for TSC (Track Structure Capital) work. Increase ownership and accessibility to the TSC and quality information should allow the engineer(s) to aid in more efficiently allocating capital resources.

In one aspect, the TSCRMS components may provide core functionality to gather requests for the most complex and high-dollar types of capital requests. The core functionality may include the divisional data entry, data validation, integrated reporting, and initial MoW prioritization. The components may also provide MoW staff with a capability to estimate budget costs for requests based on unit cost parameters. MoW staff may also have the capability to use weighted parameters to assign priorities to requests by request type. Some of the weighted parameters use step functions and do not show linearity. MoW staff may adjust the bias of any weighted parameter based on business needs. MoW staff may also have the capability to approve specific requests based on executive guidance.

Moreover, in other aspects, the TSCRMS may include alerting divisional staff to changes in track (or pipeline) quality measures and an active workflow management system for capital requests. The result may provide all participants with an improved understanding of overall data quality and process issues. Sequencing the workflow and alerting features may reduce overall system complexity and costs.

The TSCRMS may provide the engineer(s) and Roadmasters with an ability to initiate TSC requests. During the initiation process the division staff may be able to view the current track (or pipeline) quality information for the segments under consideration. The division engineer(s) may be able to prioritize all requests from their division to reflect production work, work plans, and relative criticality to the division. The division engineer(s) may also add such text notes to the request as they feel pertinent to future analysis.

MoW engineer(s) may be able to review capital requests as they are entered by division or by MoW staff. MoW engineer(s) may also have visibility of track quality and usage information across the corporation's requests and across the corporate network of other established databases. MoW may have an ability to open and close the budget submission calendar for each capital request type. Once the budget calendar is closed, division engineer(s) may submit requests only for the next fiscal year cycle.

MoW engineer(s) may also have the capability to set both cost factors for maintenance activities and weights for key decision factors. The TSCRMS may use the cost and weight factors to calculate both cost for each capital request and for requesting initial MoW priority. MoW engineer(s) may have the capability to either (a) revise the weight factors for prioritization or (b) override the priority of specific individual capital requests. For traceability, overwriting individual request priority may require inclusion of a short justification.

Upon approval of the Track Structure Capital Plan, MoW Engineer(s) may trigger the TSCRMS to close the planning fiscal year (FY). The TSCRMS may move the approved requests to the Approved FY Plan, update the unapproved requests for consideration in the next yearly planning cycle, and notify the division engineer(s) staff that the final FY plan is available for their review.

The TSCRMS may also enhance core functionality by increasing integration of the request system with corporate information and by increasing decision support processes within the system. MoW engineer(s) may trigger a review of the Production Report maintenance actions against the planning list of capital requests. Any work within a requested area of track may trigger a notice to that division's engineer(s) staff. The system may prompt the division to review the capital request against the production maintenance and to revise the request as appropriate.

Track quality status information (MGT, wear, tie condition, etc.) may be captured based on information in corporate systems at the time the request is created. MoW staff may also be provided with the capability of triggering a refresh of the track quality information. Changes beyond MoW-set thresholds may flag TSC requests for additional consideration by division engineer(s).

The TSCRMS may provide division engineer(s) with a capability of requesting changes (modifications and cancellations) to the active fiscal year (FY) capital plan. The managing change requests may enable a company to increase the accuracy in executing the current year and increase the effectiveness of capital utilization.

The TSCRMS may also provide the capability to report on capital plans across multiple years. During product development, the project team may apprise the business stakeholders of the estimate to converting prior year spreadsheets into TSCRMS format. The business stakeholders may determine the advisability of converting historical data or allowing TSCRMS history to start with this fiscal year's information.

The TSCRMS may provide the division and MoW engineer(s) with the ability to collect TSC requests and to automate the prioritization process. As part of the automated processes, the system may provide the capability for knowledgeable, authorized individuals to override the specific calculated values to reflect technical factors not economically captured in this targeted system. A history of the remarks and justifications for variances may provide an easily readable view of the evolution of a request(s).

Architecturally, the TSCRMS may build upon the new Engineering Portal. Use of the portal provides both low-cost access to required data sources, a pre-established set of server services, and an interface familiar to the current user base.

The TSCRMS may support integration of the capital request process with track quality information and may allow division engineer(s) to analyze network conditions to maintain safe track while effectively using capital resources. The centralized repository of capital requests improves tracking and accountability through the approval process to improve Sarbanes-Oxley compliance. The system may build upon, for example, engineering, EngIS (a tracking system for tracking infrastructure assets), portal and the mid-tier repositories of corporate information on track status and usage.

TSCRMS may benefit engineering divisions, Maintenance of Way department, and the overall corporate capital plan beginning with the first capital budget planning cycle. The largest benefits of TSCRMS may derive from the reduced losses during the execution of a capital plan. The improved visibility of requests may allow the division engineer(s) and MoW to review proposed capital expenditures to verify that requests reflect current information on track quality and represents the best utilization of capital resources.

TSCRMS may also benefit the division staff throughout the year by allowing engineer(s) to establish capital requests through the majority of the fiscal year. Continuous planning may allow the staff to avoid late year overloads of work that have traditionally resulted in increased errors and omissions in the capital request.

TSCRMS may also benefit MoW Engineer(s) and executives by providing mechanisms to view all requests throughout the year. The continuous planning allows MoW to actively monitor the division's assessment of their track conditions. The oversight may allow more accurate forecast changes in the current and future capital needs.

This project may enable division engineer(s) staffs, Roadmasters, and MoW engineer(s) to realign work to focus on knowledge skills rather than data manipulation. Presenting track quality data may allow divisional personnel to take a more proactive role in development of management plans for their areas. MoW job tasks may focus more on the evaluation of business and technical factors in developing the most effective capital plan.

By way of example, six months or so prior to the start of the fiscal year, the division engineer(s) may begin updating a spreadsheet with sections in the divisional area that require structure work. The division uses paper-based documents to compare conditions of various track segments. The division engineer(s) can research track quality and usage information from EngIS site for each segment individually. The division engineer(s) use their appraisals to complete a spreadsheet for each type of capital request.

Continuing the example, starting about five months prior to the fiscal year, MoW engineer(s) staffs may begin combining track quality and usage information with the spreadsheets from the engineering divisions. The track information is typically pulled from multiple sources including files for wear, gross tonnage, and others. Since capital requests normally span several track master segments, MoW personnel may typically aggregate data from some sources to match the span of the requests. Matching request and segment data may be time consuming, as MoW must correct both aggregation errors and data entry errors from the division staff.

Once the request information is matched with track information, MoW engineer(s) must apply cost factors and priority weights. MoW engineer(s) may develop prioritized listings of requests reflecting the needs of the corporation against the capital available. The prioritized lists may be sorted spreadsheets for each request type. The lists may be reviewed by MoW and other corporate staffs to validate the listings to reflect all corporate priorities. Multiple review sessions may result in either shifting weight factors assigned to specific factors or case by case decisions to include or exclude specific requests.

The Roadmasters and division engineer(s) staff may use a web browser to access the engineering web site (e.g., EngIS). When creating or editing a capital request, the application may present the user with corporate information on track wear, inspection, tonnage, geometry, and other applicable information. The engineer(s) can view on screen the track information for all track segments within the scope of the capital request. The engineer(s) may also view and clear alerts on the capital requests for pre-existing, open request and for completed production report work on the sections under consideration. The divisional engineer(s) may be able to modify or cancel requests to reflect the on-screen information. The division staff may add text comments to request when they see the need to clarify the logic behind a request or its priority. The system may automatically capture the time and the ID of the person updating a request.

MoW staff may be able to view any and all requests immediately after the division submits it. MoW engineer(s) may have the capability to review requests after they are created, make their own comments and/or request clarification from the division. MoW engineer(s) may elect to divide a division's need into multiple requests and modify the original request. MoW staff may also have the ability to update the request data to reflect more current inspection or usage data. MoW staff may view the requests a division has flagged for having Production Work, in the segment or other reasons. Visibility of flagged requests may allow division and MoW to proactively verify the continued need for a capital request.

Near the end of the fiscal year, MoW engineer(s) may be able to close the planning window for the next fiscal year. When MoW engineer(s) close a request types planning window, the system may automatically set the request for the following fiscal year. Similarly, MoW engineer(s) may have the ability to preclude division staff from updating requests once the prioritization process begins. Division engineer(s) may need to communicate needed modifications to MoW staff separately for their action.

During prioritization, MoW staff may set cost factors and priority weights for structured capital requests. MoW engineer(s) may trigger the TSCRMS to use the factors and weights to calculate the corporate priorities for each production type. MoW engineer(s) may be able to review the resulting priority lists to insure the results reflect the corporate needs. MoW engineer(s) may elect to include/exclude specific requests or may decide to adjust the weight factors and rerun the prioritization process.

Once the Track Structure Capital plan is approved for the fiscal year, MoW engineer(s) may finalize the electronic version of the plan. The system may make a snapshot of the approved requests and its associated factor tables that went into the prioritization process. The divisions may have immediate access to the approved lists for their planning and use.

According to principles of the invention, the organization of the business requirements may reflect their sequence for a successful request. Exception processes provide insights into the complexity of underlying business rules and interactions. The architecture of the engineering portal and the business needs may drive the system requirements.

The engineering staff may use the TSCRMS system to review quality and usage information on their track. Based upon the reported status of the track and their knowledge of local conditions, the division engineer(s) may create TSC requests, such as on-line in the corporation's central repository for requests. The TSCRMS may validate information as the division and MoW staffs enter the data. Based upon dynamically set parameters, the TSCRMS may prompt for clarification or additional justification.

MoW engineer(s) may adjust key values and categories to reflect changing business needs. Allocation of budget dollars, criteria for track selection, determination of wear thresholds are some of the essential settings MoW must be able to set and adjust several times throughout the budget process. The settings provide the basis for automatically calculating the priority ranking of the requests in each of the request types. The system may use the budgeted fund amounts to determine in priority which projects may be funded. Any oversight management may have the capability to direct MoW engineer(s) to specifically include or exclude projects from the funded list to reflect strategic priorities and other factors.

The TSCRMS system may be a component of the engineering portal and may utilize the architecture and services of EngIS. TSCRMS may place a minimal process load on the architecture that may include WebSphere and Oracle servers. The highest processor utilization and disk access may be during the periodic track quality updates (quarterly) and during the annual budget planning process.

The TSCRMS back-end interfaces may pull information from data sources already in use by EngIS. No additional mainframe interfaces are required to support the TSCRMS system.

System security and user authentication of TSCRMS may be provided using LDAP with SECP. Levels of authority may be defined within each system. Some users may be configured as read only, others may have update authority for specific areas within each system, system administrators may manage security access authorization and reference table updates. Each authority level and capability may be defined in more detail, as required by a specific implementation/deployment requirement.

Transaction integrity may be built into each screen and triggers may manage auto-updates if and where required. Batch processing may be needed to back feed information to the residual mainframe stores as required by remaining mainframe systems needing access to view data components, as necessary.

Recovery integrity may be built into each screen and triggers may manage auto-updates if and where required. Batch processing may be needed to back feed information to the residual mainframe stores as required by remaining mainframe systems needing access to view the data components necessary.

Recovery and restart requirements may be dependent on, for example, the Oracle store backup, and outages and the Web Server outages and may be managed accordingly.

The primary security roles provided by TSCRMS may include:
TSCRMS administrator—who may be able to assign user to roles.
MoW engineer(s)—who may be able to create requests, update requests, manage reference tables and initiate application-wide processes (e.g., quality updates, budget recalculations).
Division engineer(s)—who may be able to create and update requests for their division's track while the budget-planning calendar is open.
Track Engineers & Roadmasters—who may be able to create requests for the division, while the budget-planning calendar may be “open.”
Employees—authenticated employees may be able to view open requests on a specific segment of track.

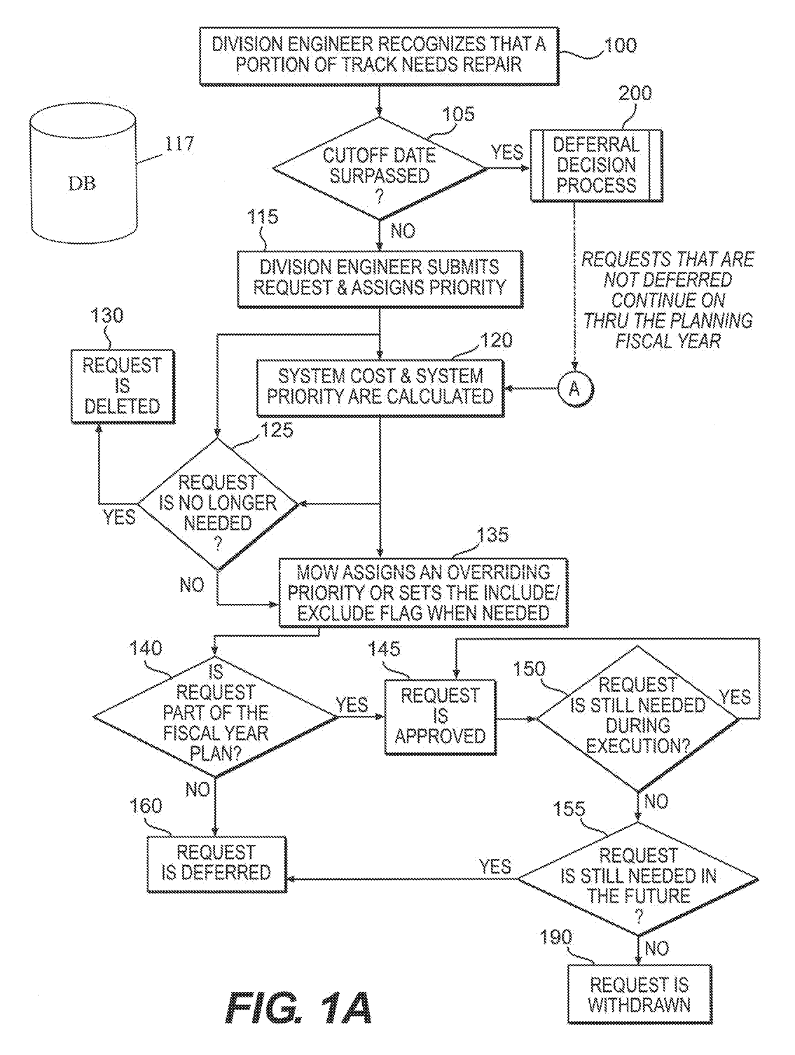

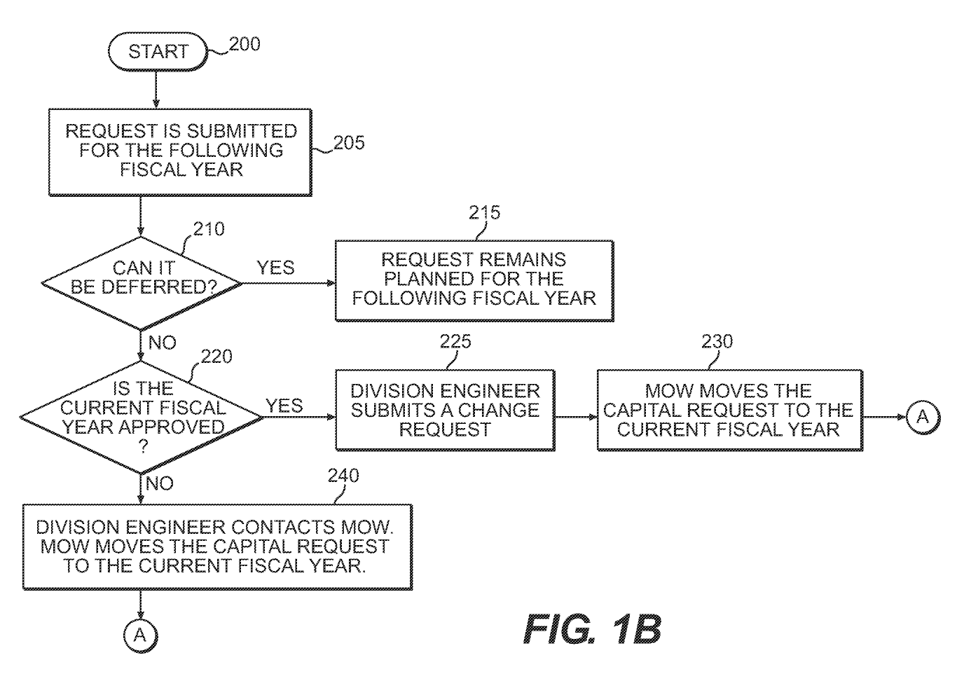

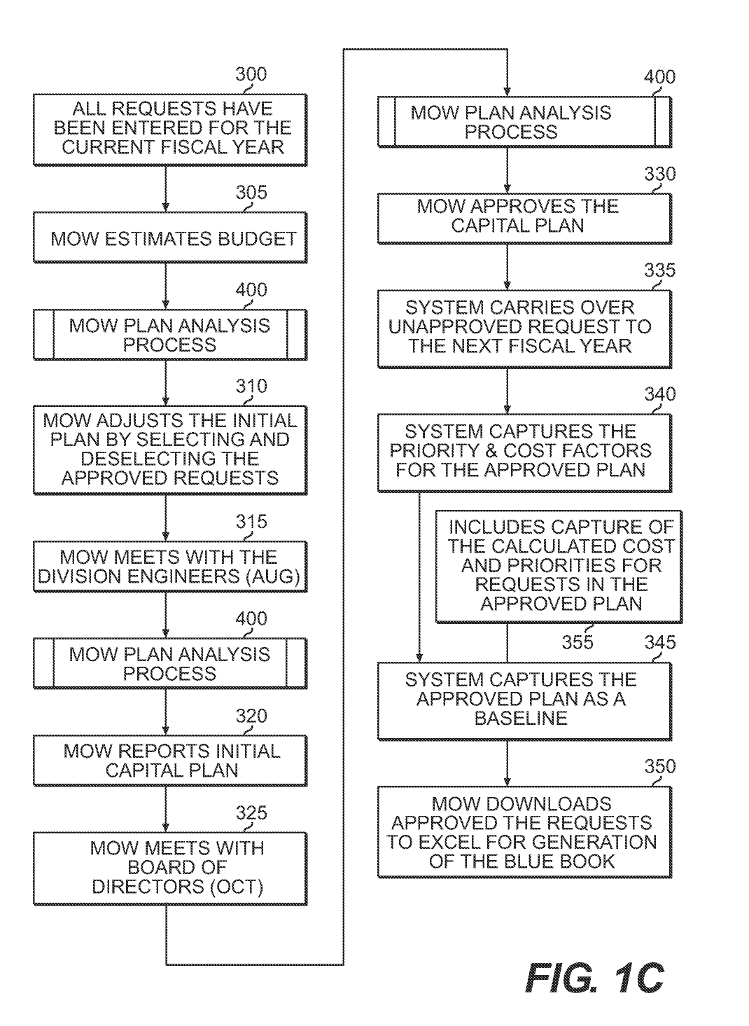

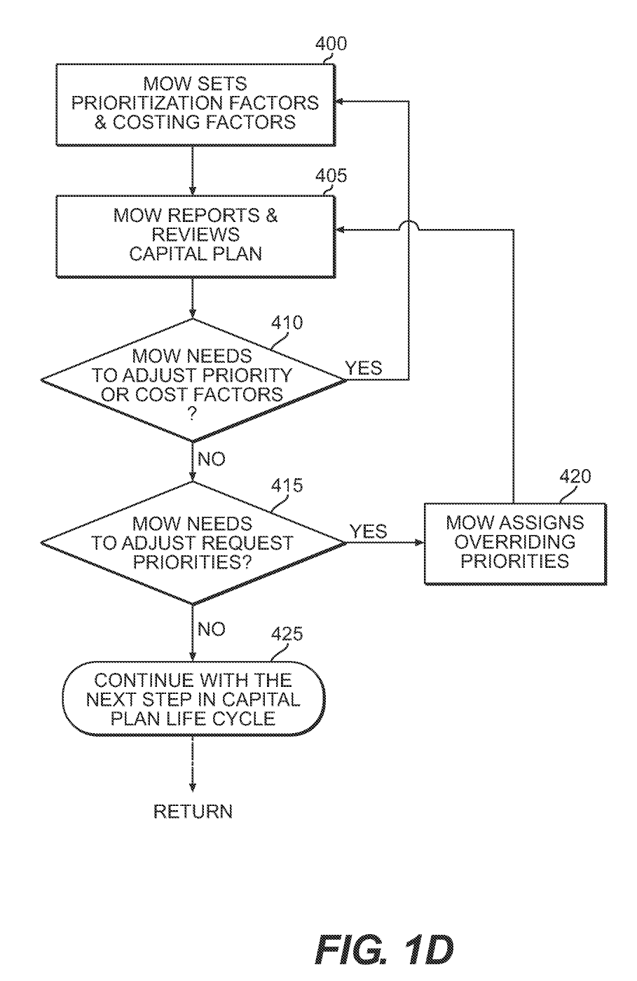

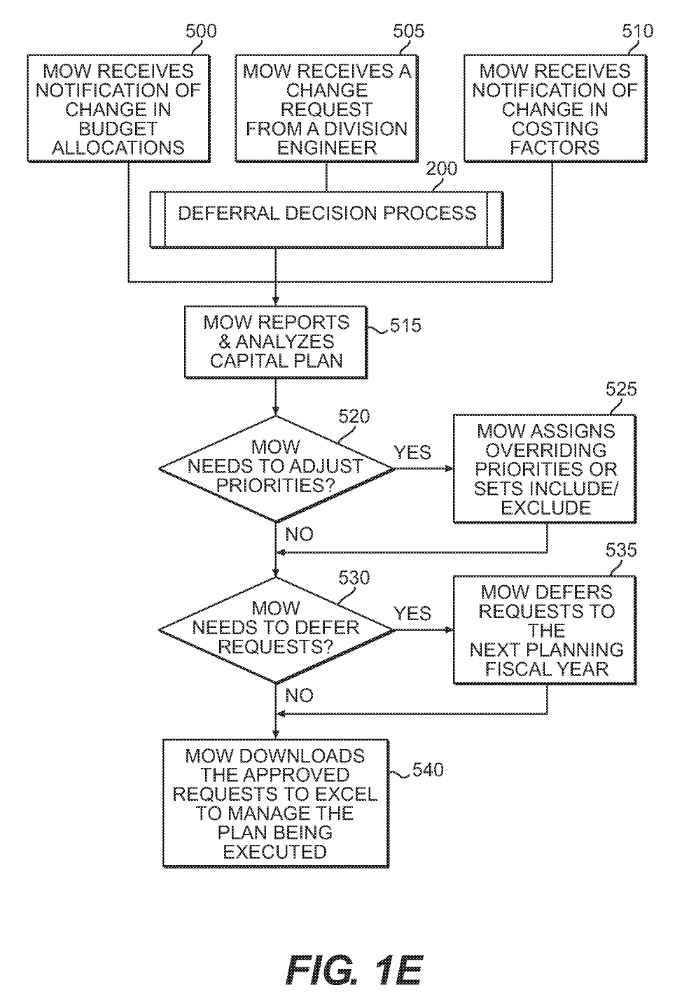

FIG. 1A is a flow diagram showing steps of an embodiment for requesting capital, performed according to principles of the invention. FIG. 1A (and also FIGS. 1B-1E and all other flow diagrams herein) may equally represent a high-level block diagram of components of the invention implementing the steps thereof. The steps of FIG. 1A and all other flow diagrams, and the graphical user interfaces described herein, may be implemented on computer program code in combination with the appropriate hardware such as a computerized engineering station or a client-server computer arrangement, for execution thereon. This computer program code may comprise a computer program product and be stored on storage media such as a diskette, hard disk, CD-ROM, DVD-ROM or tape, as well as a memory storage device or collection of memory storage devices such as read-only memory (ROM), random access memory (RAM), memory stick, or a computer-accessible electronic database. Additionally, the computer program code can be transferred to a workstation over the Internet, or other type of network.

At step 100, an engineer(s) (e.g., a division engineer) may recognize that a portion of the track may need repair based on data maintained in a data repository such as a computerized database 117 (which may be available to all steps in FIGS. 1A-1F). The data may be presented via a suitable computerized display interface, such as an engineering station. A prompt or other indication may alert to the fact that the portion of track may need repair. At step 105, a check may be made whether or not a cut-off date for decision making has been surpassed. This may be a computer maintained scheduled date and a check performed automatically by computer. If yes, then the process continues at step 200, a sub-process which returns, described more below in relation to FIG. 1B. If no, at step 115, the division engineer(s) may submit an electronic request for the repair capital and assign priority, conveyed and maintained electronically. This request may be maintained electronically. At step 125 a check may be made whether the request is still needed, perhaps based on business changes, or perhaps competing priority decisions. (Step 125 may be parallel to other steps). If not still needed, at step 130, the request may be deleted. Continuing in parallel, as needed, at step 120, system cost and system priority may be automatically calculated based on cost factors of the repair and/or based on pre-established priority guidelines.

If request is still needed at step 125, or continuing from step 120, at step 135, MoW may assign an overriding priority or may set the include/exclude flag when needed. That is, a special higher priority may be set (or lowered) and/or an item may be specifically excluded from capital consideration for a business reason. This may be maintained electronically. A check may be made at step 140 to determine whether or not the request is part of the fiscal year plan. If yes, at step 145, the request may be approved. A check may be made at step 150 whether or not the request is still needed during execution. If yes, then the process may continue at step 145. If no, at step 155, a check is made to determine if the request is still needed in the future. If yes, at step 160, the request may be deferred. If no, at step 170, the request may be withdrawn.

FIG. 1B is a flow diagram showing steps of an embodiment for a deferral decision process, performed according to principles of the invention, starting at step 200. At step 205, an electronic request may be submitted for the following (or next) fiscal year. At step 210, a check may be made to determine if the request may be deferred, perhaps based on priority or other required condition to be met. If yes, at step 215, the request may remain planned for the following fiscal year. If no, at step 220, a check may be made to determine if the current fiscal year has been approved. This status may be maintained electronically, such as in database 117. If yes, then at step 225, the engineer(s) may submit a change request electronically. At step 230, MoW may move the capital request to the current fiscal year, perhaps based on priorities and/or override authorization. If no at step 220, then at step 240, the engineer(s) may contact MoW staff and MoW staff may move the capital request to the current fiscal year, perhaps with an override.

FIG. 1C is a flow diagram showing steps of an embodiment for a capital life cycle plan, performed according to principles of the invention. At step 300, all requests may be entered for the current fiscal year and may be maintained in database 117. At step 305, MoW staff may estimate a budget and proceed to plan an analysis process, as described in relation to FIG. 1D, starting at step 400. At step 310, MoW staff may adjust the initial plan by selecting and deselecting the approved requests. At step 315, MoW staff may meet with the engineer(s), perhaps around mid-year of that year. Step 400 is a subprocess described more fully in relation to FIG. 1D. At step 320, MoW staff may report the initial capital plan, maintained electronically. At step 325, a meeting may be planned with the Board of Directors or oversight group. A MoW staff plan analysis may be performed, as shown in relation to FIG. 1D. At step 330, MoW staff may approve the capital plan. At step 335, all unapproved requests may be carried over to the next fiscal year. At step 340, the system may capture priority and cost factors for the approved plan. At step 345, the system may capture the approved plan as a baseline and may include capture of the calculated cost and priorities for requests in the approved plan. At step 350, MoW staff may download the approved requests to an Excel spreadsheet, for example, for generation of a Blue Book project plan. Step 355 may be a sub step of step 345 and includes capturing of calculated costs and priorities for requests in the approval plan.

FIG. 1D is a flow diagram showing steps of an embodiment for a MoW plan analysis, performed according to principles of the invention. At step 400, MoW staff may set prioritization factors and costing factors associated with the approved requests. These factors may be maintained in database 117. At step 405, MoW reports and reviews the capital plan. At step 410, a check is made whether or not to adjust priority or cost factors, perhaps based on enterprise goals or directives. If yes, at step 400, the process may repeat and continue at the beginning of the process. If no, at step 415, a check is made whether or not MoW needs to adjust request priorities. This may be heeded, for example, if priorities are in conflict, missing priorities, or known conditions that require resolution for previously unforeseen reasons. If yes, at step 420, MoW may electronically assign overriding priorities, based on such considerations, including perhaps as one or more of operational risk factors, environmental risk factors, design risk factors, potential revenue loss risk, amount of use, critical path, customer expectation risk, and the like. The process continues at step 405. If no, at step 425, MoW may continue with the next step in the capital plan life cycle.

FIG. 1E is a flow diagram showing steps of an embodiment for a MoW plan analysis, performed according to principles of the invention. Multiple entry points may exist for this process denoted by reference numerals 500, 505 and 510. The notifications described in this process may be maintained electronically with data updates to database 117, for example. At step 500, MoW may receive notification of a change in budget allocations. At step 510, MoW may receive notification of a change in costing factors. At step 505, MoW may receive an electronic change request form from an engineer(s). Step 200 is a deferral decision process discussed more fully at FIG. 1B. At step 515, MoW may report and analyze the capital plan, with any recommendations and revisions maintained electronically. A check may be made at step 520 whether MoW may need to adjust its priorities, based on criteria such as enterprise goals, recent events, business opportunities, legal considerations, or the like. If yes, at step 525, MoW may electronically assign overriding priorities or sets include/exclude before continuing the process. If no, at step 530, a check may be made whether or not MoW may need to defer any requests, based on criteria such as enterprise goals, recent events, legal considerations, business opportunities, and the like. If yes, at step 535, MoW may defer the requests to the next planning fiscal year before continuing the process. If no, at step 540, MoW may download the approved requests to Excel, or the like, to manage and/or implement the plan being executed.

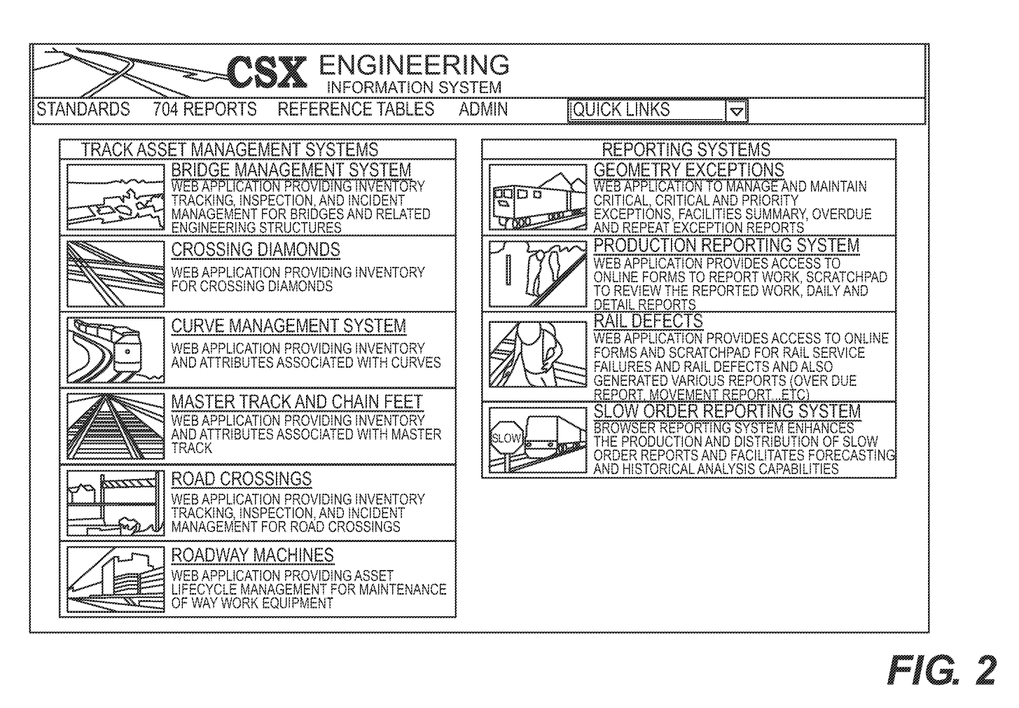

FIG. 2 is an illustration of an exemplary user interface for gaining access to portions of the TSCRMS, configured according to principles of the invention. The user interface may also represent the components for executing the steps for receiving input, processing input and providing output by a computerized engineering system. FIG. 2 shows examples of online access for data collection and priority setting including an asset management system (left side column of user selectable choices) and a reporting system (right hand side column of user selectable choices). The portion labeled “Bridge Management System” may be a part (e.g., a subsystem) of an asset management system (labeled “Track Asset Management System) and provides user access to a web based application for providing inventory tracking, inspection and incident management for bridges and related structures.

Still referring to FIG. 2, the portion labeled “Crossing Diamonds” may be a part of an asset management system (labeled “Track Asset Management System”) and may provide user access to a web based application for providing inventory, location data, and financial and condition status of crossing diamonds. The portion labeled “Curve Management System” may be a part of an asset management system (labeled “Track Asset Management System”) and may provide user access to a web based application for providing inventory and attributes associated with curves on tracks; and may include track curve inventory and curve condition data. The portion labeled “Master Track and Chain Fleet” may be a part of an asset management system (labeled “Track Asset Management System”) and may provide user access to a web based application for providing inventory and associated attributes associated with master track. The portion labeled “Road Crossings” may be a part of an asset management system (labeled “Track Asset Management System”) and may provide user access to a web based application for providing inventory tracking, inspection, and incident management for road crossing equipment (e.g., warning lights, crossing guards, etc). The portion labeled “Roadway Machines” may be a part of an asset management system (labeled “Track Asset Management System”) and may provide user access to a web based application for providing asset lifecycle management for maintenance of way work equipment.

The right half portion of FIG. 2 represents a reporting system (labeled “Reporting Systems”). Several individually accessible subsystems may be accessed through this system including “Geometry Exceptions” that may be a web based application to manage and maintain critical and priority exceptions, facilities summaries, overdue and repeat exceptions reports, and may provide priority exceptions for one or more aspects of the rail system.

Another subsystem may include “Production Reporting System” which may be a web based application for providing user access to online forms to report work, daily and detailed reports, and may provide daily production reports. Another subsystem may include “Rail Defects” which may be a web based application to permit a user to access forms and maintain data related to rail service failures, rail defects and for generating associated reports including overdue reports and movement reports, defects, service failures and the like. Another subsystem may include “Slow Order Reporting System” which may be a browser based reporting system to enhance the production and distribution of slow order reports and facilitates forecasting and historical analysis.

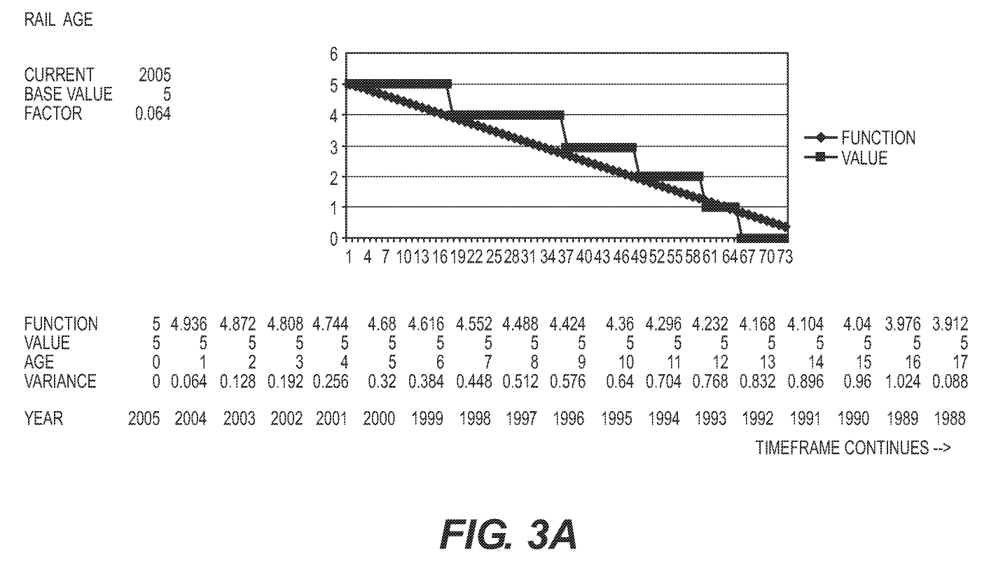

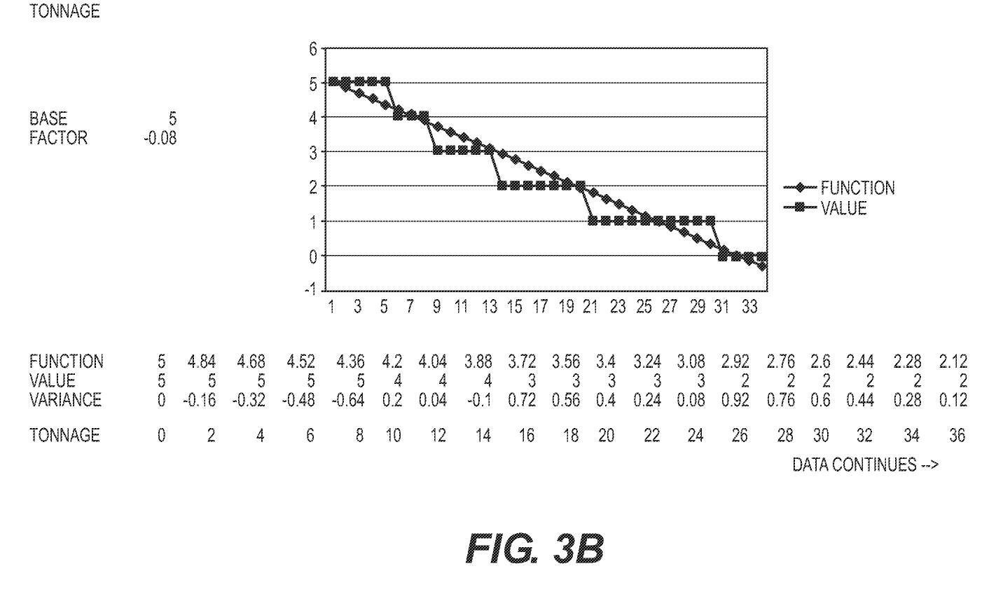

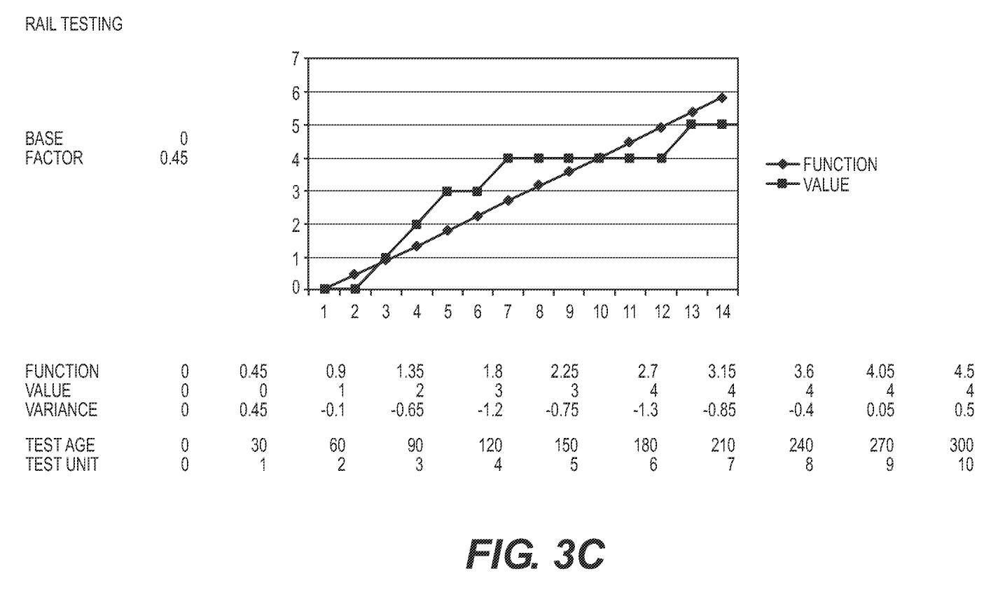

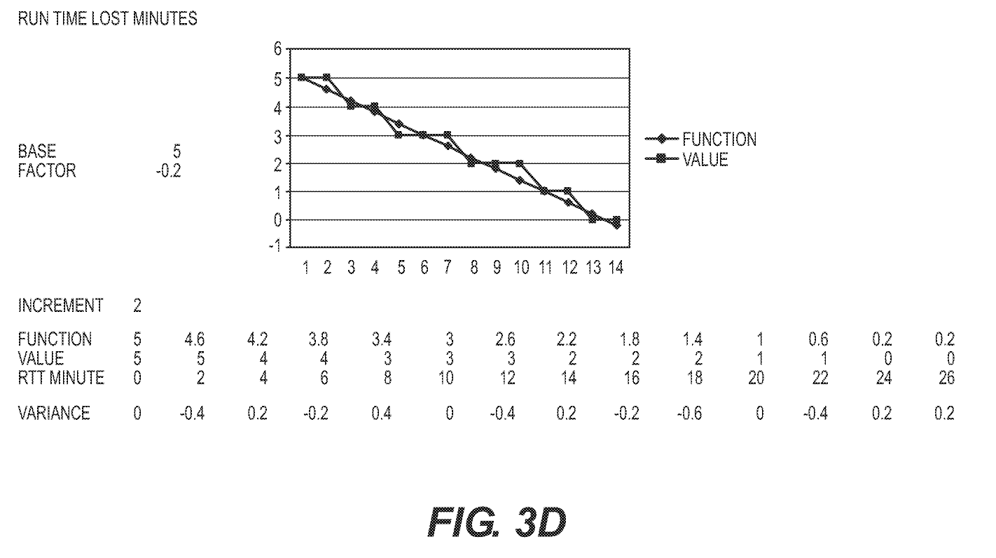

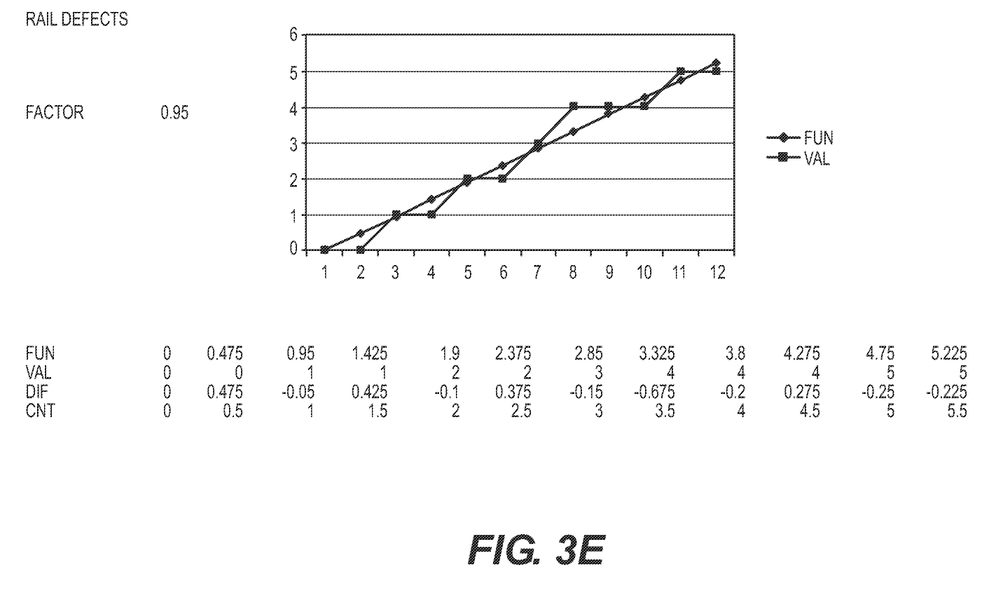

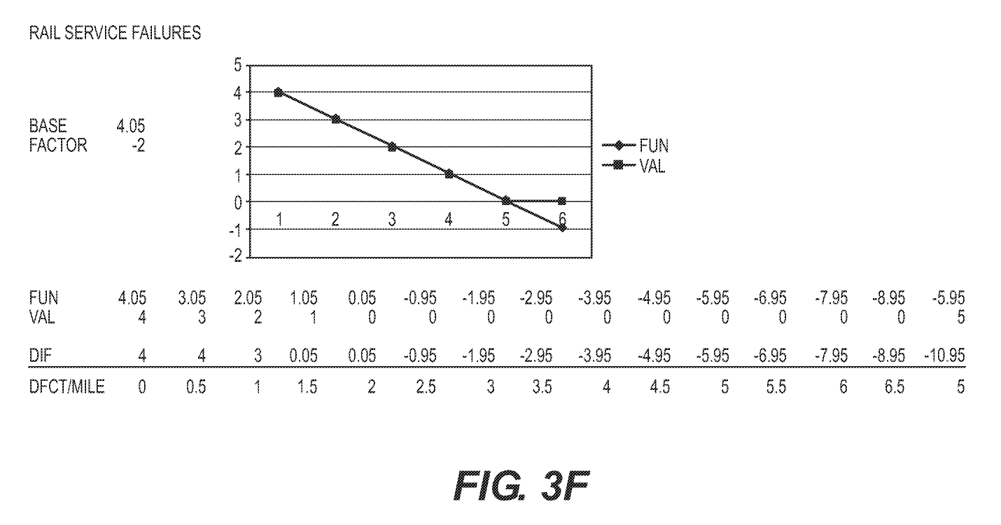

FIGS. 3A-3F are exemplary illustrations of graphs showing various exemplary types of data considered for use in priority setting, according to principles of the invention. The data of FIG. 3A-3F may be maintained by the one or more processes described herein, and may be maintained electronically such as in database 117. FIG. 3A shows information related to rail age for a select portion of rail, presentable by electronic graphical display and/or report generation, for example. Included may be information by year related to function, value, age, and variance. This information may be weighted for comparative evaluation with other rail portions that may be presented for a capital or a maintenance project, or the like. FIG. 3B shows information related to tonnage for a portion of a rail structure with information (typically weighted) for value, function and tonnage, and also for use in a comparative analysis and decision making against other projects. FIG. 3C shows information related to rail testing for a portion of a rail structure with information (typically weighted) for function, value, variance, test age, test unit, as well as for use in a comparative analysis and decision making against other projects. FIG. 3D shows information related to run time lost minutes for a portion of a rail structure with information (typically weighted) for function, value, variance, and run time lost minutes. This information may also be for use in a comparative analysis and decision making against other projects. FIG. 3E shows information related to rail defects for a portion of a rail structure with information (typically weighted) for function, value, defects and count, and also for use in a comparative analysis and decision making against other projects. FIG. 3F shows information related to rail service failures for a portion of a rail structure with information (typically weighted) including function, value and defects per mile. This information may also be for use in a comparative analysis and decision making against other projects.

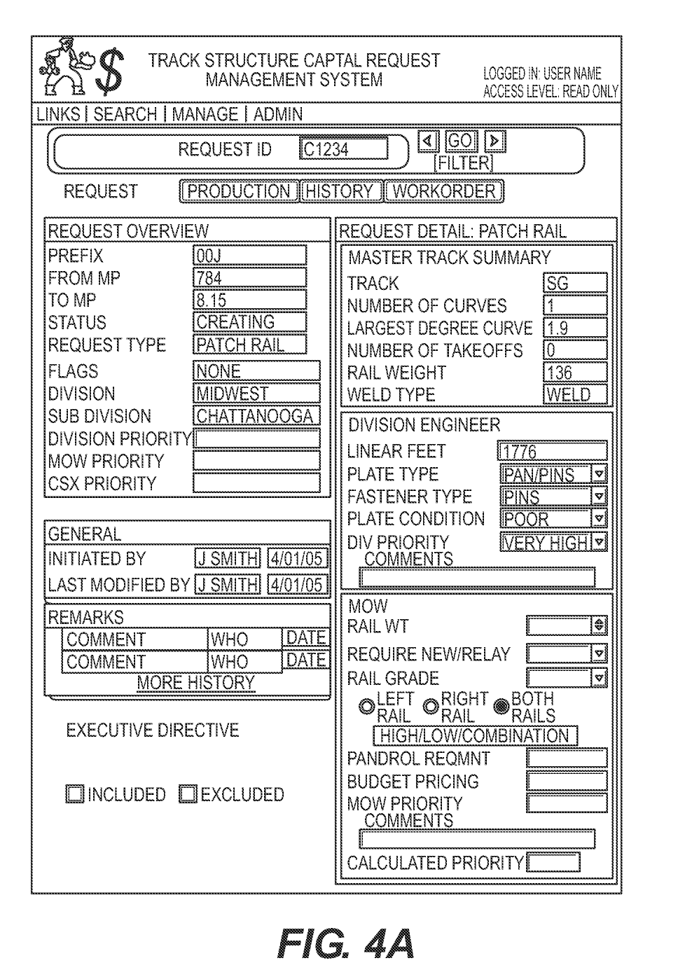

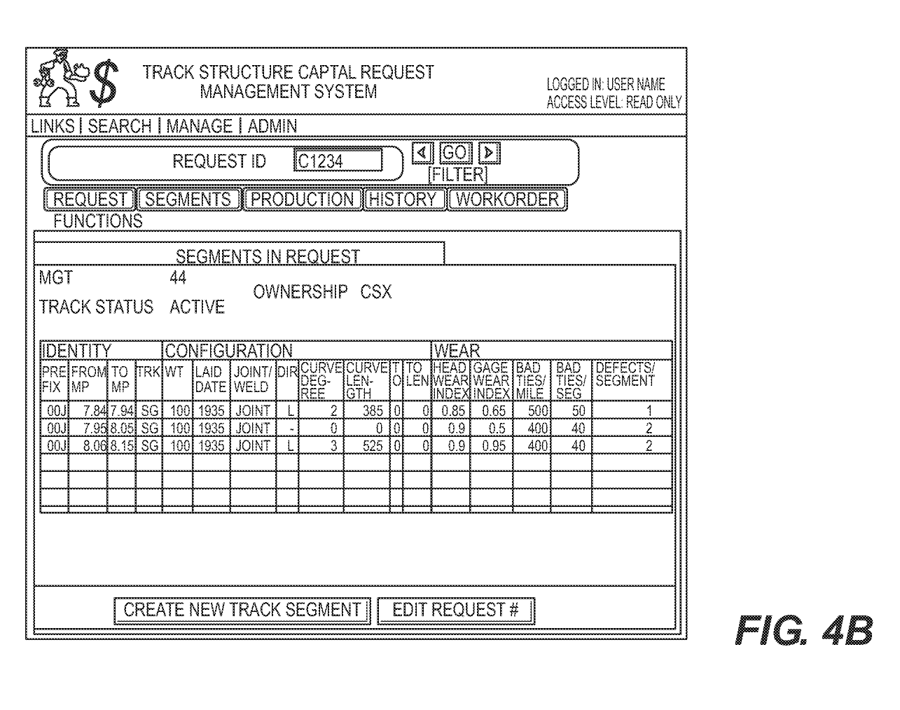

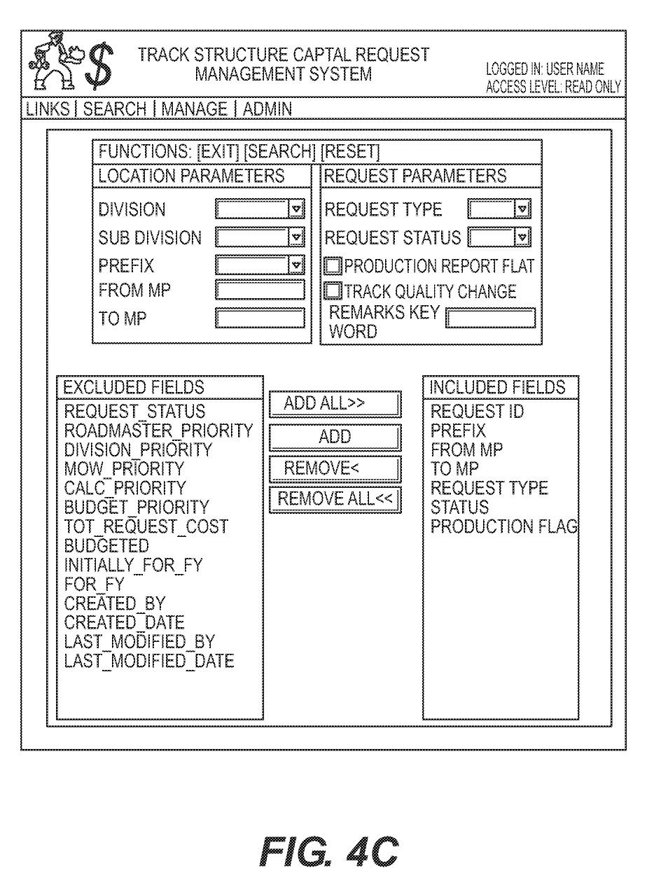

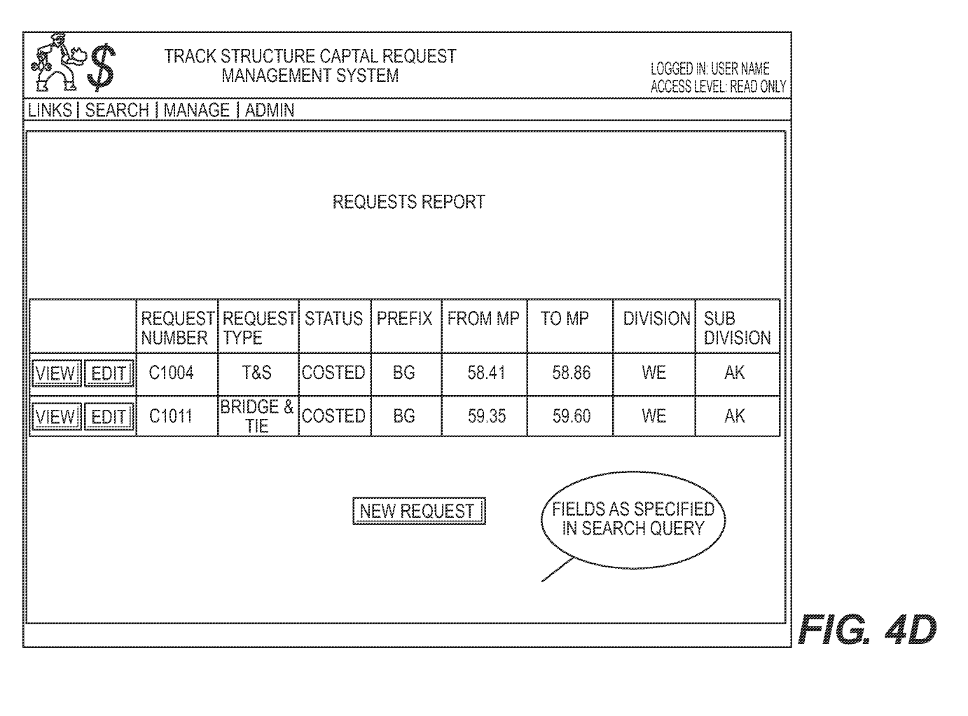

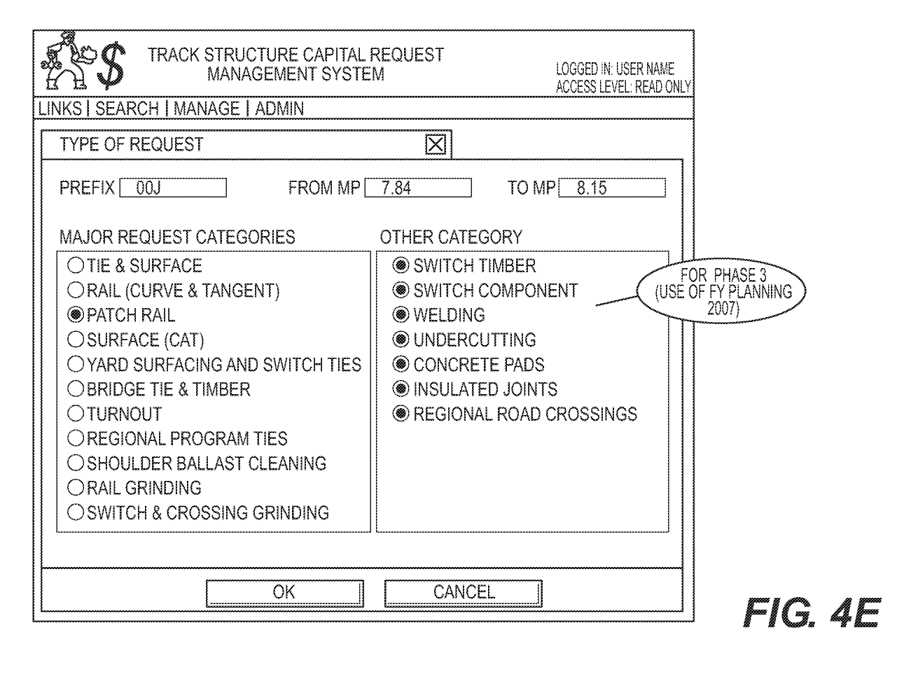

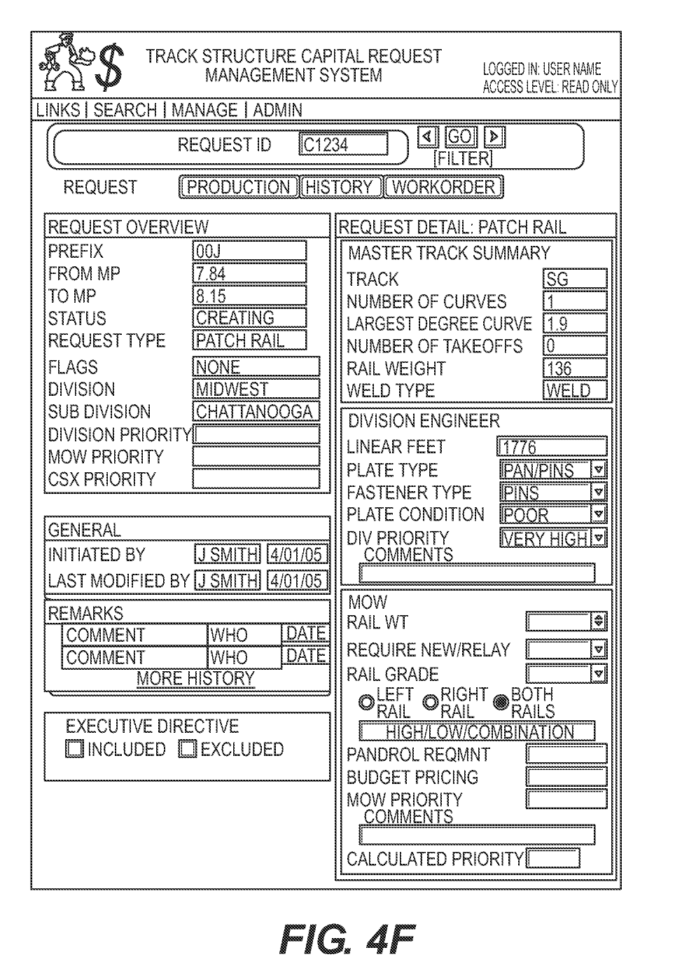

FIGS. 4A-4F are exemplary illustrations representing user interfaces of various functions provided by TSCRMS, and the corresponding software for performing the respective functions, configured according to principles of the invention. The user interfaces of FIGS. 4A-4F may also represent block diagrams of the software components in conjunction with suitable processing computing platforms that perform the functions thereto. FIG. 4A shows a track structure capital request interface for access and updating of information related to track structures. FIG. 4B shows a track structure capital request interface for access and updating of information related to track structures or portions thereof, and factors related to the track. FIG. 4C shows user interface for selecting criteria and fields to be displayed. FIG. 4D shows a user interface for selecting criteria and fields to be displayed. FIG. 4E shows a user interface for selecting a type of request for a portion of structure by major categories. FIG. 4F shows a user interface that displays a request overview and request detail for a submission.

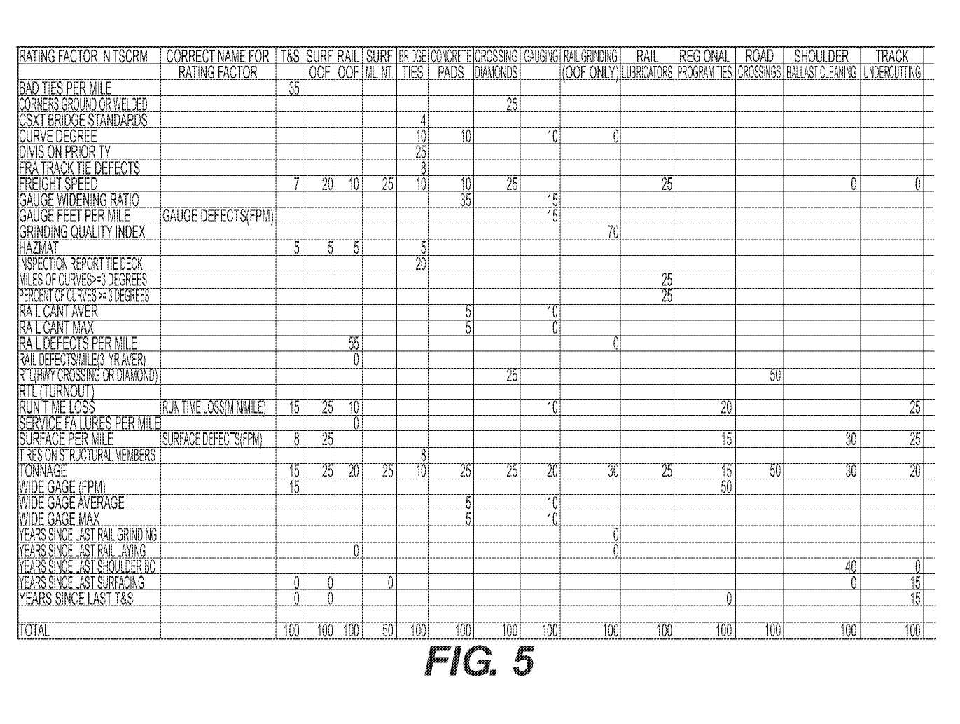

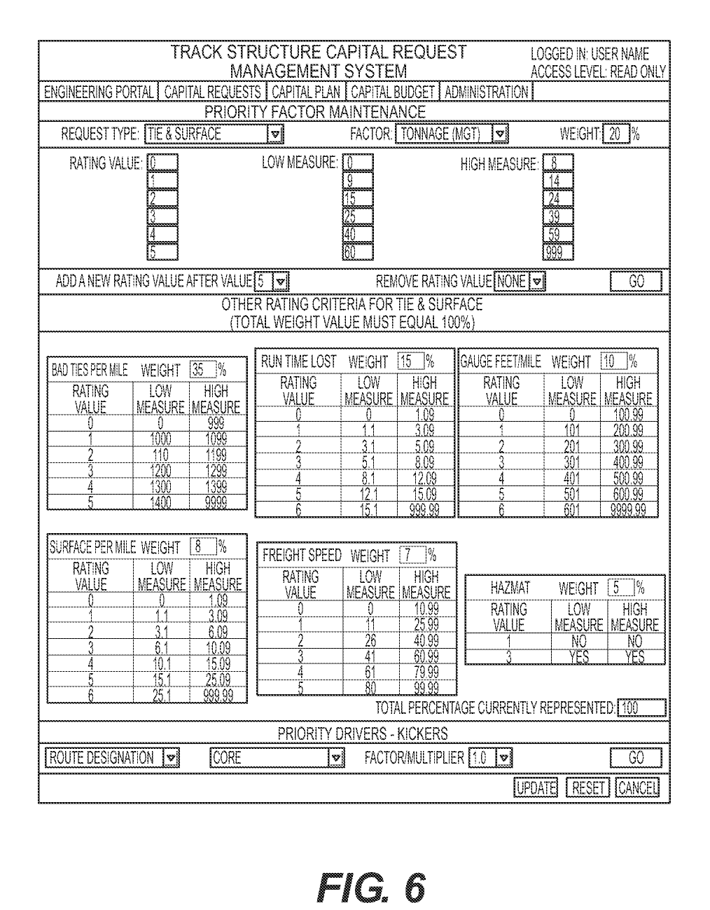

FIG. 5 is an exemplary spreadsheet showing exemplary rating factors maintained by TSCMS, which may be used to base capital decision making. FIG. 6 is an exemplary user interface of TSCMS for displaying various rating factors with low and high measures. This information of FIGS. 5 and 6 may be used to create priorities and to set capital decision criteria, for example.

Moreover, information and/or user options shown in FIG. 2 through FIG. 6 may be used to base priority setting, decision making and capital outlays.

U.S. Provisional Application No. 61/103,330 is incorporated by reference herein in its entirety, including the Appendix.

While the invention has been described in terms of exemplary embodiments, those skilled in the art may recognize that the invention can be practiced with modifications in the spirit and scope of the appended claims. These examples given above are merely illustrative and are not meant to be an exhaustive list of all possible designs, embodiments, applications or modifications of the invention.

What is claimed is:

1. A computerized process for determining capital outlay, the steps comprising:
setting a priority and cost factor for a plurality of capital projects related to a railway system in an electronic database;
applying a risk factor to each of the plurality of capital projects maintained by the electronic database; and
determining a capital budget for the plurality of capital projects based on the priority, cost, and applied risk and performing at least one capital project based on the determined budget,
wherein the setting, applying, determining steps are executed on a computer processing platform.

2. The process of claim 1, wherein at least one of the capital projects is related to maintenance of a railroad structure.

3. The process of claim 1, wherein the risk factor includes at least any one of an environmental risk factor, an operational risk factor, an age risk factor, and a design risk factor.

4. The process of claim 1, wherein at least one of the capital projects is for a pipeline structure.

5. The process of claim 1, wherein the step of setting a priority includes determining a revenue generation factor.

6. A system for maintaining a rail system, comprising:
a computerized asset management system that includes a bridge management subsystem to manage bridge inventory and incidents associated with bridges, a crossing diamond subsystem to manage crossing diamond inventory and condition status of crossing diamonds, a curve management subsystem to track curve inventory and curve condition data, a master track and chain feet subsystem to maintain data related to master tracks, a road crossing subsystem to maintain data related to road crossing inventory and road crossing incidents, and a roadway machines subsystem to provide lifecycle management of maintenance of way work equipment; and
a computerized reporting system that includes a geometry exceptions subsystem that maintains and provides priority exceptions for one or more aspects of the rail system maintained at least in part by the asset managing system,
wherein the computerized asset management system and computerized reporting system facilitate management of a rail system.

7. The system of claim 6, wherein the reporting system further includes a production reporting subsystem that reports daily production.

8. The system of claim 6, wherein the reporting system further includes a rail defect subsystem that tracks rail defects and failures and generates associated reports.

9. The system of claim 6, the reporting system further includes a slow order reporting subsystem that reports slow orders and forecasting capabilities.

10. The system of claim 6, wherein any of the subsystems comprises a web based application.

11. A computer program product embodied in a computer readable medium that is accessible for execution, the computer program product includes machine executable instructions that when executed causes the execution of steps for determining capital outlay for a infrastructure system, the computer program product comprises:
a first component to set a priority and cost factor for a plurality of capital projects related to a railway system in an electronic database;
a second component to apply a risk factor to each of the plurality of capital projects maintained by the electronic database; and
a third component to determine a capital budget for the plurality of capital projects based on the priority, cost, and applied risk and performing at least one capital project based on the determined budget.

12. The computer program product of claim 11, wherein at least one of the capital projects is related to maintenance of a railroad structure.

13. The computer program product of claim 11, wherein the risk factor includes at least any one of an environmental risk factor, an operational risk factor, an age risk factor, and a design risk factor.

14. The computer program product of claim 11, wherein at least one of the capital projects is for a pipeline structure.

15. The computer program product of claim 11, wherein the first component includes determining a revenue generation factor.
